(19) United States
(12) Patent Application Publication
(10) Pub. No.: US 2015/0029931 A1
(43) Pub. Date: Jan. 29, 2015

(54) METHOD FOR TRANSMITTING DATA VIA SHARED RELAY STATION IN MOBILE COMMUNICATION SYSTEM

(71) Applicant: KOREA UNIVERSITY RESEARCH AND BUSINESS FOUNDATION, Seoul (KR)

(72) Inventors: Hyun Seok Ryu, Seoul (KR); Chung Gu Kang, Seoul (KR)

(21) Appl. No.: 14/376,745

(22) PCT Filed: Feb. 21, 2012
(86) PCT No.: PCT/KR2012/001296

§ 371 Date: Aug. 5, 2014

(30) Foreign Application Priority Data
Feb. 14, 2012 (KR) 10-2012-0014889

(51) Int. Cl. H04W 72/04; H04B 7/15

(52) U.S. Cl. CPC H04W 72/042; H04B 7/15
USPC 370/315

(57) ABSTRACT

The present invention relates to a transmitting method for minimizing the delay time for data transmission via a wired backbone network using a shared relay station (SRS), wherein the steps of transmitting data and control information using the shared relay station comprises: a) sharing a relay station between at least two base stations (BS) and b) transmitting data via at least two base stations, terminals connected to the respective base stations, and a relay station. According to the present invention, the delay time for data transmission is minimized in comparison with conventional cellular networks, as data which was transmitted to a controller of a core network via a wired backbone network in the conventional cellular networks is transmitted to base stations or terminals via a wireless link by means of a shared relay station.

### TECHNICAL FIELD

This invention relates to a transmission technique for minimizing delay time for data transmission via wired backbone network using a shared relay station (SRS).

### BACKGROUND ART

As smartphones and a variety of multimedia application services are booming, there is a demand for advanced cellular networks to accommodate fast-growing data traffics.

In particular, in order to secure economical cellular networks, bandwidth efficiency has to be maximized by increasing the maximum wireless transfer rate and an average throughput. Although the maximum possible wireless transfer rate has been so far rapidly increased through OFDM (Orthogonal Frequency Division Multiplexing) techniques and MIMO (Multi-Input Multi-Output) techniques, the bandwidth efficiency has not yet been increased proportionally.

In particular, in cellular systems using OFDMA (Orthogonal Frequency Division Multiple Access) such as IEEE 802.16e-based mobile WiMAX or 3GPP LTE, transfer rates of individual terminals are unavoidably limited by deterioration of CINR (Carrier to Interference and Noise Ratio) at cell edges, which may result in poor bandwidth efficiency of the overall system. In addition, there is a need for network construction plans to secure an economical coverage for shadowed regions or traffic-intensive regions without using a separate wired backhaul link.

As measures against the above problems, IEEE 802.16j TG (Task Group) organized within IEEE 802.16 Wireless MAN (Metropolitan Area Network) standardization group has standardized OFDMA-TDD (Time Division Duplexing)-based multi-hop wireless relay standards, through which application methods of relay techniques to cellular wideband mobile communication networks have been discussed in detail. From the discussion, the IEEE 802.16m standard and the 3GPP LTE-Advanced (LTE-A) as candidates for the IMT-Advanced standard of ITU-R consider a wireless relay station as a factor important in securing cell edge performance and extending economical coverage.

A wireless relay station-based cellular system includes dedicated relay stations for supporting a wireless relay function for terminal connection with a base station. The terminal may make direct communication with the base station or may connect to the base station over 2-hop via a single wireless relay station or multi-hop via multiple wireless relay stations. One cell serviced by one base station may be divided into several small coverage regions by multi-hop wireless relay stations, in which case all wireless relay stations can reuse the same wireless resources to achieve further increase in system capacity.

However, at boundaries of adjacent wireless relay stations, service outage increases due to reuse of the same frequency by plurality of base stations or wireless relays. For example, interference between different wireless relay stations using the same frequency connected to the same base station or interference between a base station and wireless relay stations using the same frequency, in this case the wireless relay stations may be connected to the base station.

That is, the performance of wireless relay station-based cellular system may be limited due to the service outage performance at coverage boundaries between wireless relay stations in spite of effects of throughput increase through the wireless relay stations.

In addition, since a terminal can move within a base station between multiple wireless relay stations, frequent handover may take place when considering mobility of the terminal. Thus, when compared with the conventional cellular system using no wireless relay station, the wireless relay station-based cellular system may have longer terminal handover delay time and longer handover disconnection time during which data transfer is stopped in the handover procedure.

In order that terminals located in adjacent cells in the existing cellular networks can communicate with each other, data transmitted from the terminals have to pass through a wired backbone network.

For example, assume that terminals serviced by adjacent base station 1 and base station 2 are terminal 1 and terminal 2, respectively. If terminal 1 attempts to transmit data to terminal 2, terminal 1 transmits the data to base station 1 via an uplink. Base station 1 transmits the data to a controller (or gateway) in a core network via a wired backbone network. The controller in the core network identifies an IP address from the data received from base station 1 and then transmits the data to base station 2 in which terminal 2 as a destination is located.

Base station 2 transmits the received data to terminal 2 via a downlink. Although terminal 1 and terminal 2 are located in adjacent cells, data transfer delay time is lengthened due to data transfer via the wired backbone network.

The existing wireless relay station-based cellular network has longer data transfer delay time via the wired backbone network. For example, assume that wireless relay stations serviced by adjacent base station 1 and base station 2 are relay station 1 and relay station 2, respectively, and terminals serviced by relay station 1 and relay station 2 are terminal 1 and terminal 2, respectively. If terminal 1 attempts to transmit data to terminal 2, terminal 1 transmits the data to relay station 1 via an uplink and relay station 1 transmits the data to base station 1 via an uplink. Base station 1 transmits the data to a controller (or gateway) in a core network via a wired backbone network. The controller in the core network identifies an IP address from the data received from base station 1 and then transmits the data to base station 2 in which terminal 2 as a destination is located. Base station 2 transmits the received data to relay station 2 which then transmits the data to terminal 2. That is, although terminal 1 and terminal 2 are located in adjacent cells, data transfer delay time is further lengthened as data is transfer via the wired backbone network and the wireless relay link.

Accordingly, when data transfer between terminals located in adjacent cells is required, there is a need to minimize data transfer delay time.

FIG. 1 illustrates a network 100 in which terminal 1 transmits data to terminal 2 in two adjacent cells having no wireless relay station.

It is assumed in FIG. 1 that terminal 1 and terminal 2 are connected to base station 1 and base station 2, respectively. In this case, terminal 1 transmits data to base station 1 via an uplink (terminal 1→base station 1), base station 1 transmits the data to a controller of a core network via a wired backbone network (base station 1→controller), the controller of the core network transmits the received data to base station 2 (controller→base station 2), and base station 2 transmits the data to terminal 2 via a downlink (base station 2→terminal 2).

FIG. 2 shows a network 200 in which terminal 1 connected to wireless relay station 1 transmits data to terminal 2 connected to wireless relay station 2.

It is here assumed that relay station 1 is connected to base station 1 and relay station 2 is connected to base station 2. In this case, terminal 1 transmits data to relay station 1 via an uplink (terminal 1→relay station 1) and relay station 1 transmits the data to base station 1 via an uplink (relay station 1→base station 1). Base station 1 transmits the data to a controller of a core network via a wired backbone network (base station 1→controller), the controller of the core network transmits the received data to base station 2 (controller→base station 2), and base station 2 transmits the data to relay station 2 via a downlink (base station 2→relay station 2). Finally, relay station 2 transmits the data to terminal 2 via a downlink (relay station 2→terminal 2).

In FIG. 1 and FIG. 2, since all data of cells are transmitted to adjacent cells through the controller of the core network via the wired backbone network, it is natural that data transfer delay time should be lengthened.

### DISCLOSURE

### Technical Solution

According to one embodiment of the present invention, there is provided a method of transmitting data through a shared relay station in a mobile communication system, including the steps of: scanning, by the shared relay station, downlink channels for a plurality of base stations; setting, by the shared relay station, downlink synchronization with the plurality of base stations from the scanned channels; and registering, by the shared relay station, the plurality of base stations bases on the set downlink synchronization.

According to another embodiment of the present invention, there is provided a method of transmitting data through a shared relay station in a mobile communication system, including the steps of: requesting, by a terminal, a serving base station for data local forwarding; overhearing, by the shared relay station, the data local forwarding request performed by the terminal; transmitting, by the serving base station, a hold message to the terminal and requesting a controller of a core network for the data local forwarding via a wired backbone network, when a data local forwarding request message is received from the terminal; determining, by the controller of the core network, whether or not the data local forwarding is possible based on position information of terminals and replying to the serving base station and adjacent base stations connected to a terminal to receive data in the data local forwarding; transmitting, by the serving base station, a response message received from the controller of the core network to the shared relay station; transmitting, by the serving base station, the response message to the shared relay station; transmitting, by the serving base station, a message of response to the data local forwarding request to the terminal; transmitting, by the terminal requesting the serving base station for the data local forwarding, data; and receiving, by the serving base station, the transmitted data.

### Advantageous Effects

According to one embodiment of the present invention, when terminals located in adjacent cells transmit data in a cellular mobile communication network where two or more base stations share one relay station, it is possible to minimize a packet loss probability and data transfer delay by transmitting data via a wireless link through a relay station rather than wired backbone network.

### DESCRIPTION OF DRAWINGS

FIGS. 1 and 2 are views for explaining data transfer in a conventional relay station-based cellular network.

FIGS. 3 to 6 are views data local forwarding in a shared relay station-based cellular network according to one embodiment of the present invention.

FIG. 7 is a flowchart for explaining a method of performing network entry and initialization of a shared relay station to allow one relay station to be shared by multiple base stations in the shared relay station-based cellular network according to one embodiment of the present invention.

FIG. 8 is a view for explaining a frame structure to allow a shared relay station and multiple base stations to transmit/receive data and control information via a wireless link in the shared relay station-based cellular network according to one embodiment of the present invention.

FIGS. 9 to 12 are views for explaining embodiments of setting data local forwarding without passing through a wired backbone network in the shared relay station-based cellular network according to one embodiment of the present invention.

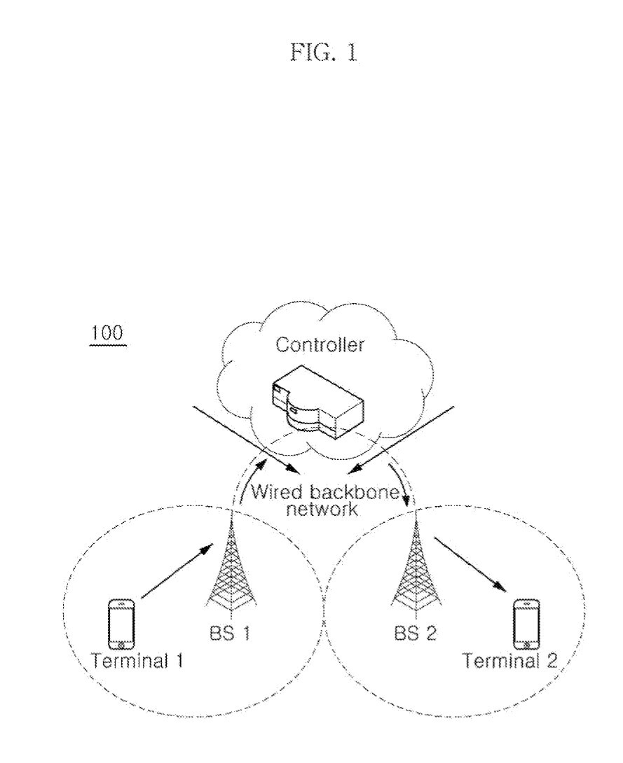

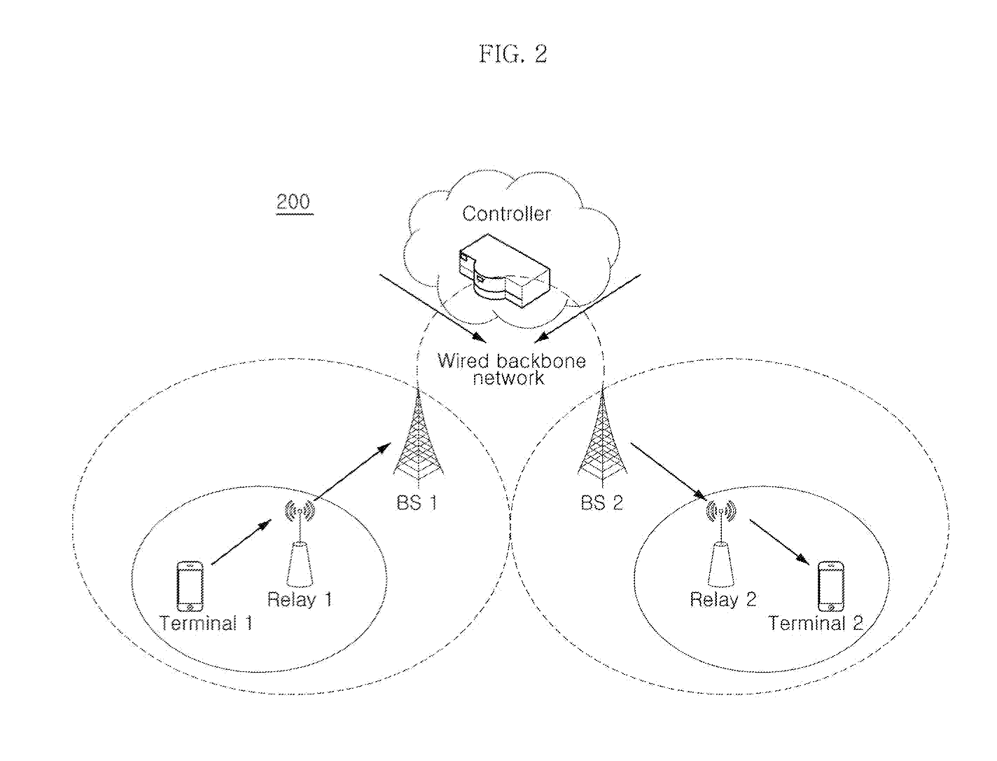

### MODE FOR INVENTION

Hereinafter, preferred embodiments of the present invention will be described in detail with reference to the accompanying drawings.

In the following detailed description of the present invention, concrete description on related functions or constructions will be omitted if it is deemed that the functions and/or constructions may unnecessarily obscure the gist of the present invention. Terminologies used herein are terms to provide proper expression of preferred embodiments of the present invention and may have different meanings depending on intention of users or operators or practices in the related art. Therefore, the definition of the terminologies should be made on the basis of contexts throughout the specification. Throughout the drawings, the same members are denoted by the same reference numerals.

In a system using a shared relay station suggested by the present invention, two or more base stations share one wireless relay station, as opposed to an existing wireless relay station-based cellular system in which one base station services a number of wireless relay stations. This allows reduction of interference caused by adjacent wireless relay stations, which can result in improvement of CINR (Carrier to Interference and Noise Ratio) and hence improvement of reliability of received data over the existing wireless relay station-based cellular system.

In addition, the shared wireless relay station allows handover message and data reception having reliability higher than that of the existing system, which can result in a minimal handover failure rate.

Moreover, since messages transmitted/received between a serving base station and a target base station via a backbone network during handover can be transmitted/received through the shared wireless relay station via a wireless link, it is possible to minimize delay time and handover disconnection time in handover performance.

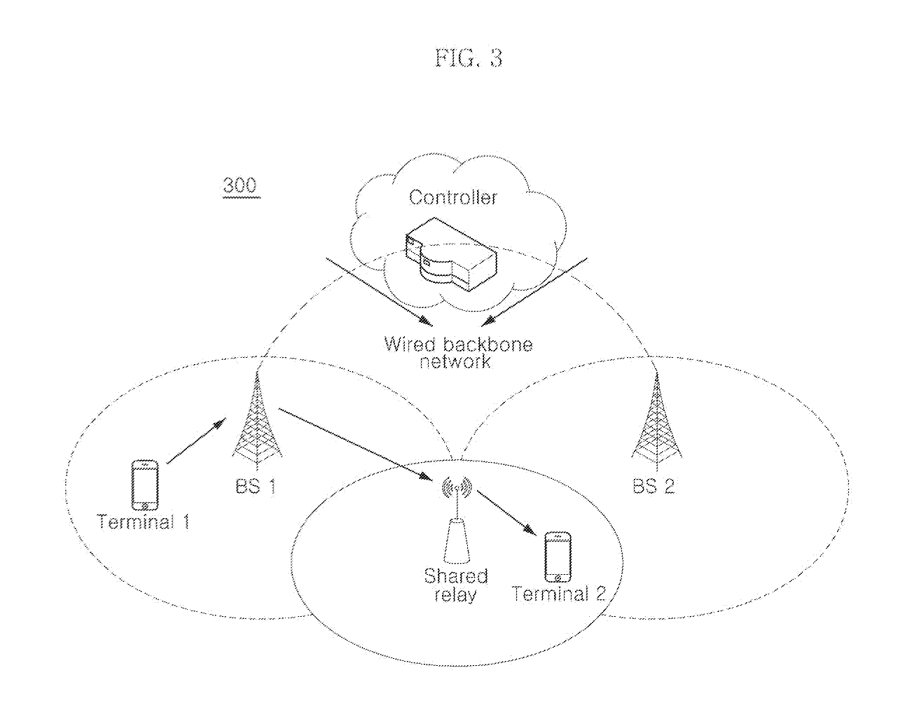

FIGS. 3 to 6 are views data local forwarding in a shared relay station-based cellular network according to one embodiment of the present invention.

In more detail, FIG. 3 shows an example of data local forwarding from a terminal connected to a base station to another terminal connected to a shared relay station without passing through a wired backbone network in the shared relay station-based cellular network according to one embodiment of the present invention

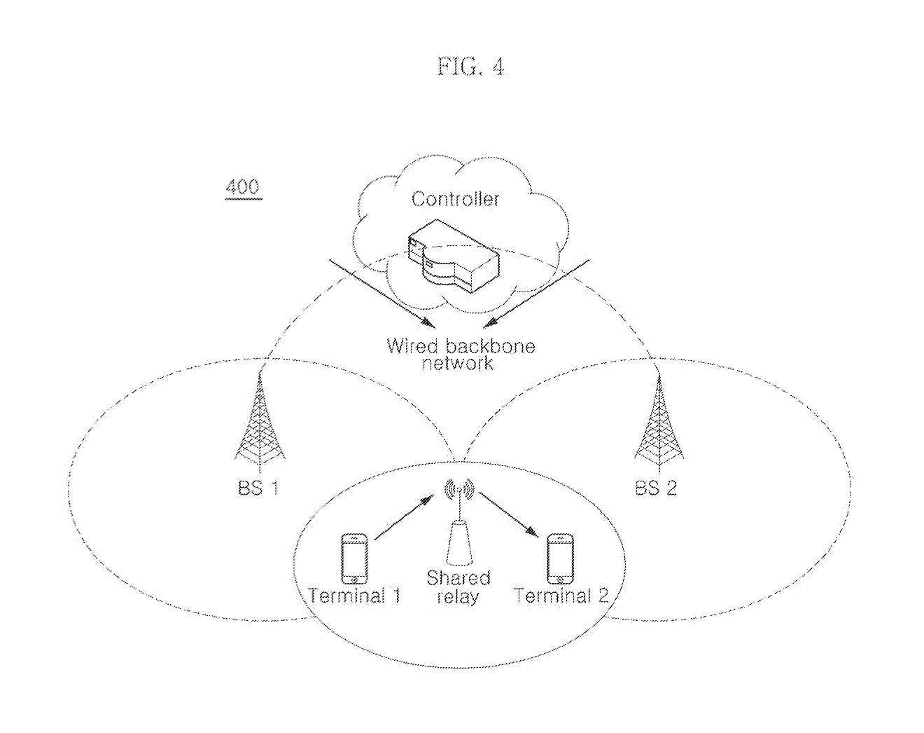

FIG. 4 shows an example of data local forwarding from a terminal connected to a shared relay station to another terminal connected to the same shared relay station without passing through a wired backbone network.

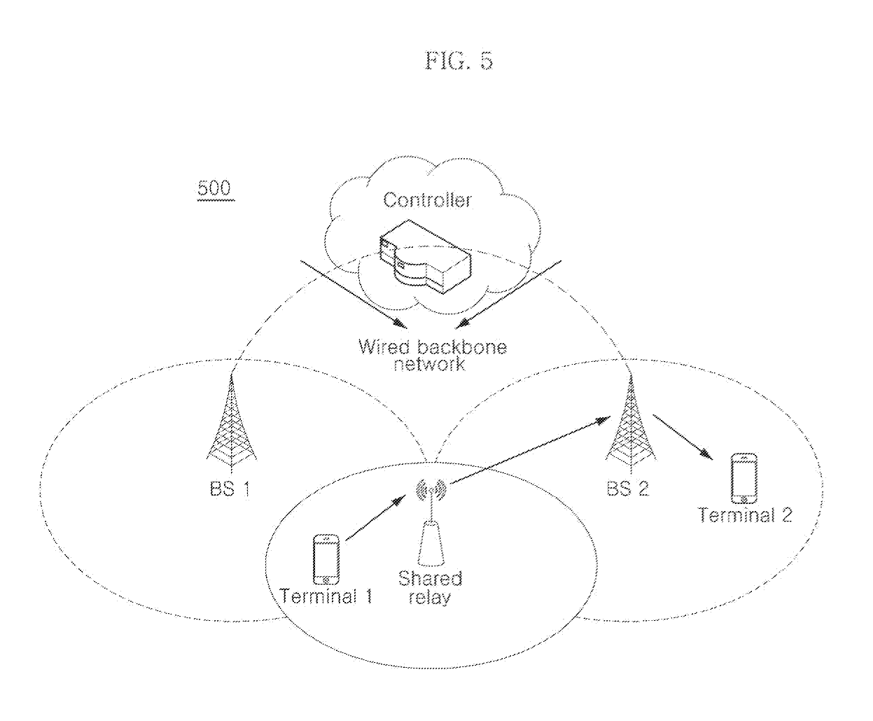

FIG. 5 shows an example of data local forwarding from a terminal connected to a shared relay station to another terminal connected to a base station without passing through a wired backbone network.

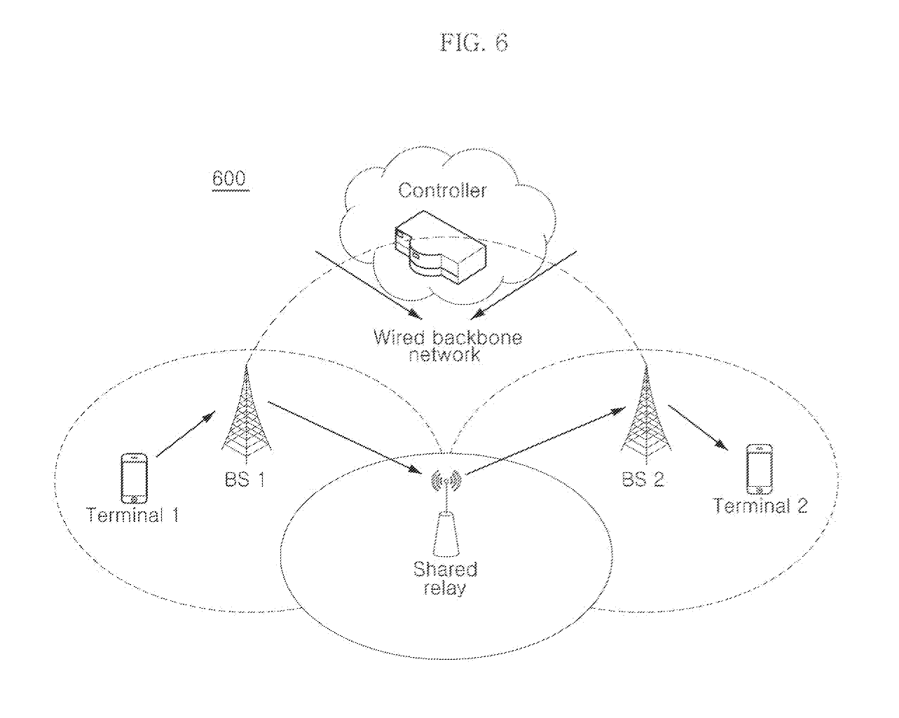

FIG. 6 shows an example of data local forwarding from a terminal connected to a base station to another terminal connected to another base station without passing through a wired backbone network.

First considering a network 300 of FIG. 3, terminal 1 is connected to base station 1 and terminal 2 is serviced through a shared relay station in a coverage region of the shared relay station. It is here assumed that terminal 1 and terminal 2 have completed data local forwarding setting for data local forwarding, and a method of setting and ending the data local forwarding will be described later. Terminal 1 transmits data to base station 1 via an uplink (terminal 1→base station 1) and base station 1 transmits the data to the shared relay station via a downlink (base station 1→shared relay station). The shared relay station transmits the data to terminal 2 serviced by the shared relay station (shared relay station→terminal 2).

Considering a network 400 of FIG. 4, both of terminal 1 and terminal 2 are serviced through a shared relay station in a coverage region of the shared relay station. As in FIG. 3, it is here assumed that terminal 1 and terminal 2 have completed data local forwarding setting for data local forwarding. Terminal 1 transmits data to the shared relay station via an uplink (terminal 1→shared relay station) and the shared relay station relays the data to terminal 2 via a downlink (shared relay station→terminal 2).

Considering a network 500 of FIG. 5, terminal 1 is serviced through a shared relay station in a coverage region of the shared relay station and terminal 2 is serviced from base station 2 out of the coverage region of the shared relay station. It is also here assumed that terminal 1 and terminal 2 have completed data local forwarding setting for data local forwarding. Terminal 1 transmits data to the shared relay station via an uplink (terminal 1→shared relay station) and the shared relay station relays the data to base station 2 via a downlink (shared relay station→base station 2). Finally, base station 2 transmits the data to terminal 2 serviced by base station 2 (base station 2→terminal 2).

Considering a network 600 of FIG. 6, terminal 1 and terminal 2 are serviced through base station 1 and base station 2, respectively. It is also here assumed that terminal 1 and terminal 2 have completed data local forwarding setting for data local forwarding. Terminal 1 transmits data to base station 1 via an uplink (terminal 1→base station 1) and base station 1 transmits the data to the shared relay station via a downlink (base station 1→shared relay station). The shared relay station relays the data to base station 2 via an uplink (shared relay station→base station 2) and base station 2 transmits the data to terminal 2 (base station 2→terminal 2).

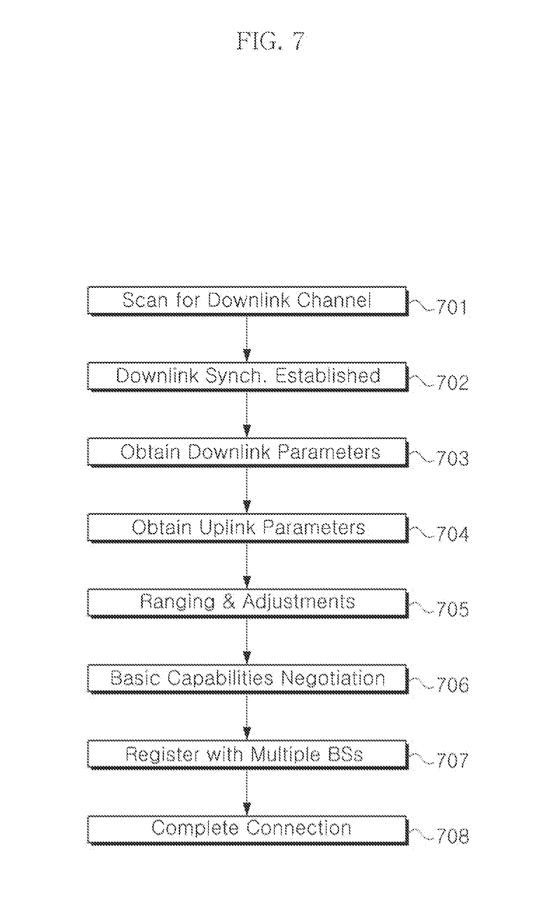

FIG. 7 is a flow chart for explaining a method of performing network entry and initialization of a shared relay station to allow one relay station to be shared by multiple base stations in the shared relay station-based cellular network according to one embodiment of the present invention.

FIG. 7 shows a network entry and initialization procedure required for connection of a shared relay station to multiple base stations. The shared relay station receives control signals (for example, preambles) transmitted by ambient base stations via a downlink and sets frame synchronization with the ambient base stations.

In the shared relay station according to one embodiment of the present invention, downlink channels for multiple base stations are scanned (Step 701) and downlink synchronization with the multiple base stations can be set from the scanned channels (Step 702).

At this time, the shared relay station uses control information transmitted via a downlink of each base station, for example, downlink map information, to acquire a profile of base station transmission power and data burst, for example, downlink information such as FEC code type and the like.

As one example, the shared relay station can receive control signals from the multiple base stations and set the downlink synchronization by setting frame synchronization.

The shared relay station according to one embodiment of the present invention can register the multiple base stations based on the set downlink synchronization.

For the registration, the shared relay station according to one embodiment of the present invention can acquire at least one of downlink information and uplink information about the multiple base stations.

In order to acquire at least one of downlink information and uplink information about the multiple base stations, the shared relay station can acquire the downlink information about the multiple base stations (Step 703) and use the uplink control information transmitted via the downlink to acquire uplink frame configuration information and parameters for the ranging (Step 704).

For example, the shared relay station, which acquired the downlink information, uses the uplink control information transmitted via the downlink of each base station, like, the uplink map information, to acquire the uplink frame configuration information and parameters (ranging code, ranging region and so on) for initial ranging.

The shared relay station according to one embodiment of the present invention can perform ranging and adjustment with the multiple base stations based on at least one of the downlink information and the uplink information (Step 705).

The shared relay station, which acquired the parameters for the downlink and uplink of adjacent base stations, performs ranging and adjustment in order to adjust timing offset and frequency offset with each base station and transmission power of the shared base station.

The shared relay station according to one embodiment of the present invention can negotiate with the multiple base stations for basic capability (Step 706).

After completion of the ranging procedure, the shared relay station negotiates with adjacent base stations for its own basic capability. At this time, the adjacent base stations select a shared relay station which can be shared by them through a negotiation procedure. The shared relay station completed the negotiation performs a procedure of registration with the adjacent base stations to share the shared relay station. After successful registration procedure, the multiple base stations share the shared relay station.

The shared relay station according to one embodiment of the present invention can register the multiple base stations based on the set downlink synchronization (Step 707) and complete connection with the multiple base stations (Step 708).

In order to scan downlink channels for the multiple base stations, the shared relay station according to one embodiment of the present invention can use control information transmitted by the multiple base stations via downlink channels to acquire at least one of profiles of base station transmission power and data burst.

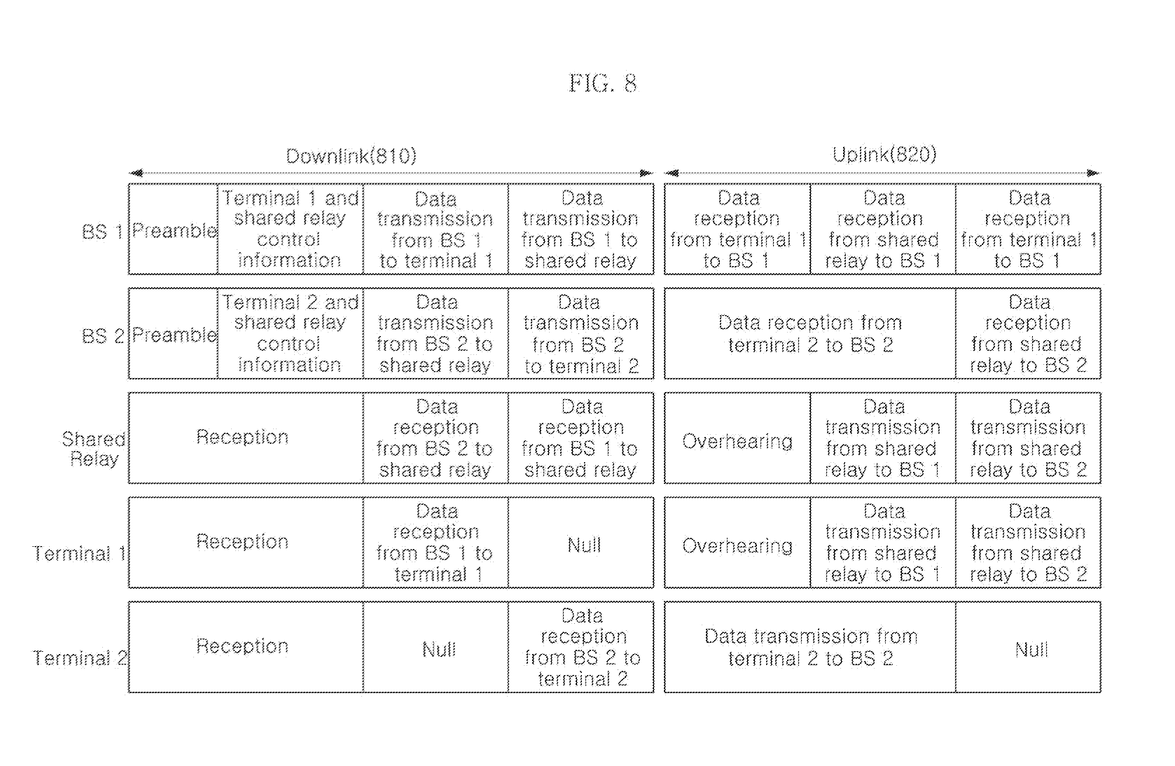

FIG. 8 is a view for explaining a frame structure to allow a shared relay station and multiple base stations to transmit/receive data and control information via a wireless link in the shared relay station-based cellular network according to one embodiment of the present invention.

FIG. 8 is a view for explaining a frame structure 800 to allow a shared relay station and multiple base stations to transmit/receive data and control information via a wireless link in the shared relay station-based cellular network according to one embodiment of the present invention. This will be described with an OFDMA-TDD system.

Referring to FIG. 8, each frame is divided into a downlink 810 and an uplink 820, each of which is again divided into a section in which a terminal communicates with a base station or a shared relay station and a section in which a bases station communicates with a shared relay station. A this time, a division ratio of each section can be variably set depending on a traffic distribution within a cell, in which case proper load balancing is required for resource efficiency.

In the present invention, since all terminals are transparent to the shared relay station, the shared relay station in the frame structure of FIG. 8 does not transmit a preamble for frame synchronization and cell search and control information indicating resource allocation information for each user (for example, map information for an IEEE 802.16-based system and PDCCH for 3GPP LTE-based system). Accordingly, all terminals receive the preamble and the control information from a serving base station to which the terminals are connected. That is, all terminals acquire the frame synchronization and the resource allocation information from the connected serving base station and receive data burst from the serving base station or the shared relay station.

The section for communication between the base station and the shared relay station allocates resources among adjacent base stations sharing the shared relay station in an orthogonal manner (time division or frequency division). The time division is used in FIG. 8. Such orthogonal resource allocation may be achieved through negotiation between the base stations and the shared relay station in the network entry and initialization procedure of the shared relay station illustrated in FIG. 7.

As an alternative, the orthogonal resource allocation may be controlled by a controller of a core network via a wired backbone network in the network entry and initialization procedure.

Since the shared relay station does not transmit the preamble, the terminals are transparent to the shared relay station. Therefore, when terminals near a coverage of the shared relay station transmit data via an uplink, it is considered that the terminals transmit the data to a base station to which the terminals are connected. In addition, when the terminals near the coverage of the shared relay station receive data via a downlink, it is considered that the terminals receive the data to the base station to which the terminals are connected. In particular, when the terminals transmit the data via the uplink, a specific resource section is allocated to the uplink of the shared relay station so that the shared relay station can overhear this data transmission. Such overhearing resource allocation may be achieved through negotiation between the base stations and the shared relay station in the network entry and initialization procedure of the shared relay station illustrated in FIG. 7.

As an alternative, the overhearing resources may be allocated by a controller of a core network via a wired backbone network in the network entry and initialization procedure.

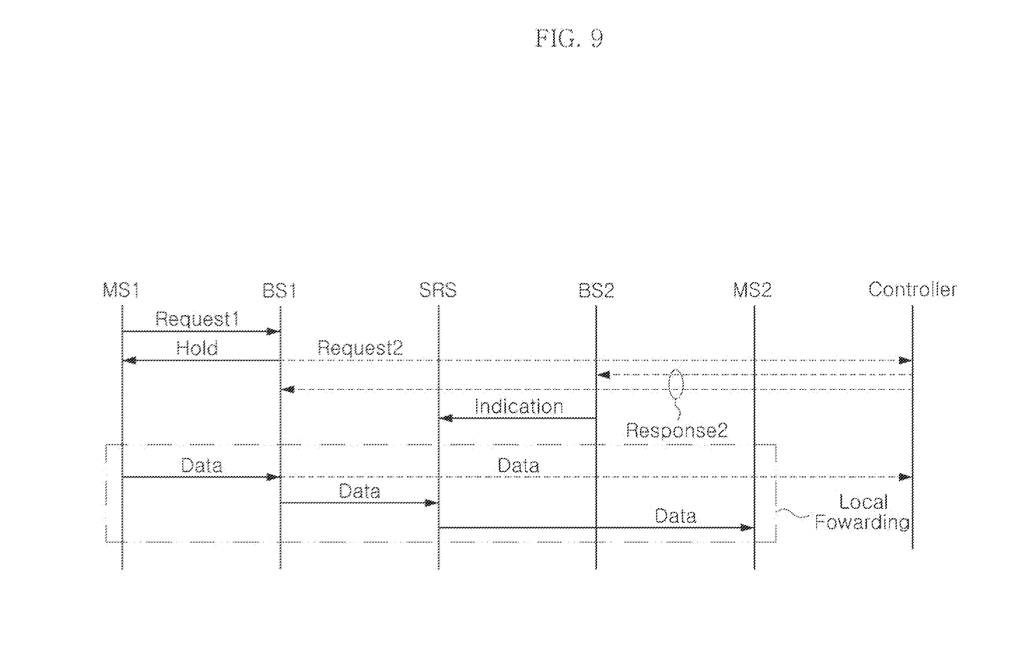

FIGS. 9 to 12 are views for explaining embodiments of setting data local forwarding without passing through a wired backbone network in the shared relay station-based cellular network according to one embodiment of the present invention.

FIG. 9 shows an example of data local forwarding setting to allow terminal 1 connected to a base station to perform data local forwarding to terminal 2 connected to the shared relay station without passing through a wired backbone network in the shared relay station-based cellular network according to one embodiment of the present invention. FIG. 9 can be used in the scenario of FIG. 3, details of which are as follows.

Terminal 1 requests base station 1 connected to terminal 1 for data local forwarding to terminal 2 (Request1). At this time, terminal 1 may send base station 1 a request message to request base station 1 for resources required for the data local forwarding. Base station 1 transmits, to terminal 1, a response to the data local forwarding request message received from terminal 1 and a hold message indicating that terminal 1 is waited while base station 1 is inquiring of a controller of a core network whether or not data local forwarding from terminal 1 serviced by base station 1 to terminal 2 not serviced by base station 1 is possible.

At the same time, base station 1 transmits a data local forwarding request message for terminal 1 to the controller of the core network (Request2).

The controller received the data local forwarding request message confirms which base station is connected to terminal 2, and transmits a response message indicating whether or not the data local forwarding request is possible to base station 1 connected to terminal 1 and base station 2 connected to terminal 2 (Response2). Base station 1 transmits, to terminal 1, a message of response to the data local forwarding request (Response1) and can allocate resources required for terminal 1 to transmit data via an uplink.

Upon receiving the response message (Response2) from the controller of the core network, base station 2 instructs the shared relay station (SRS) to directly transmit data received from base station 1 to terminal 2 (Indication). When this procedure is completed, the data local forwarding in order of terminal 1→base station 1→shared relay station→terminal 2 is achieved. At this time, base station 1 may transmit the data received from terminal 1 for the data local forwarding, as indicated by a dotted line, to the controller of the core network via a wired backbone network.

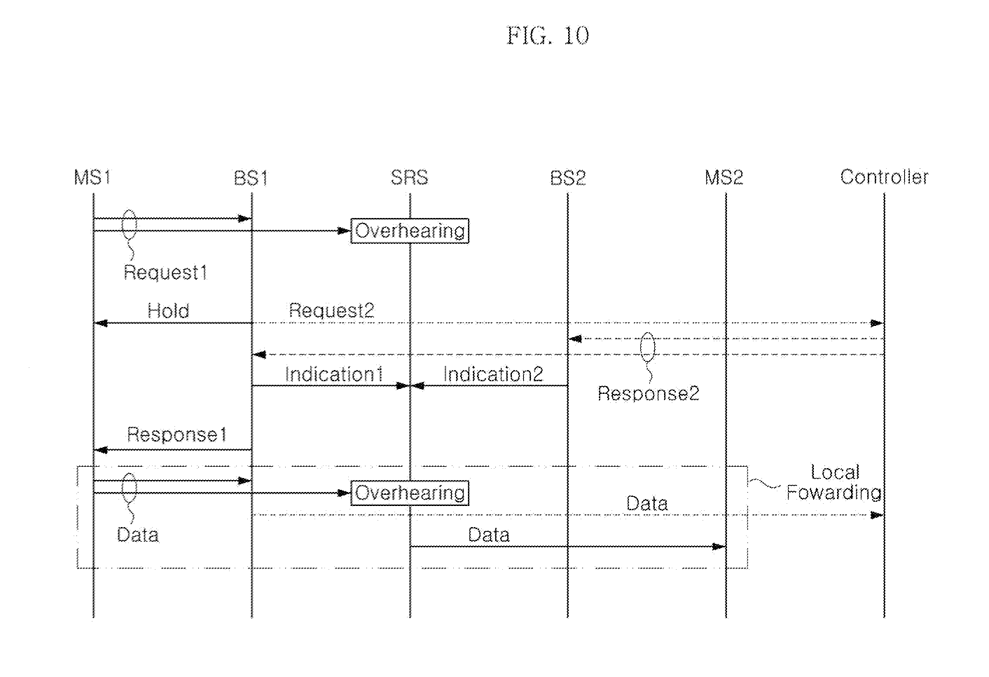

FIG. 10 shows an example of data local forwarding setting to allow terminal 1 connected to a shared relay station to perform data local forwarding to terminal 2 connected to the shared relay station without passing through a wired backbone network in the shared relay station-based cellular network according to one embodiment of the present invention. FIG. 10 can be used in the scenario of FIG. 4, details of which are as follows.

Terminal 1 requests base station 1 connected to terminal 1 for data local forwarding to terminal 2 (Request1). At this time, terminal 1 may send base station 1 a request message to request base station 1 for resources required for the data local forwarding. Since terminal 1 is transparent to the shared relay station although it is located in a service region of the shared relay station, terminal 1 transmits a Request1 message to base station 1. At this time, the Request1 message transmitted by terminal 1 can be overheard (or eavesdropped) by the shared relay station. Base station 1 transmits, to terminal 1, a response to the data local forwarding request message received from terminal 1 and a hold message indicating that terminal 1 is waited while base station 1 is inquiring of a controller of a core network whether or not data local forwarding from terminal 1 serviced by base station 1 to terminal 2 not serviced by base station 1 is possible.

At the same time, base station 1 transmits a data local forwarding request message for terminal 2 to the controller of the core network (Request2). The controller received this request message confirms which base station is connected to terminal 2, and transmits a response message indicating whether or not the data local forwarding request is possible to base station 1 connected to terminal 1 and base station 2 connected to terminal 2 (Response2). Upon receiving the response message (Response2) from the controller of the core network, base station 1 transmits, to the shared relay station, a message indicating that terminal 1 connected to base station 1 transmits data to the shared relay station (Indication1) and base station 2 transmits, to the shared relay station, a message indicating that terminal 2 connected to base station 2 transmits data to the shared relay station (Indication2).

Base station 1 transmits, to terminal 1, a message of response to the data local forwarding request (Response1) and can allocate resources required for terminal 1 to transmit data via an uplink. When this procedure is completed, the data local forwarding in order of terminal 1→shared relay station→terminal 2 is achieved. At this time, since terminal 1 is transparent to the shared relay station, terminal 1 transmits local forwarding data to base station 1 and the shared relay station overhears the local forwarding data transmission. Base station 1 may transmit the data received from terminal 1 for the data local forwarding, as indicated by a dotted line, to the controller of the core network via a wired backbone network.

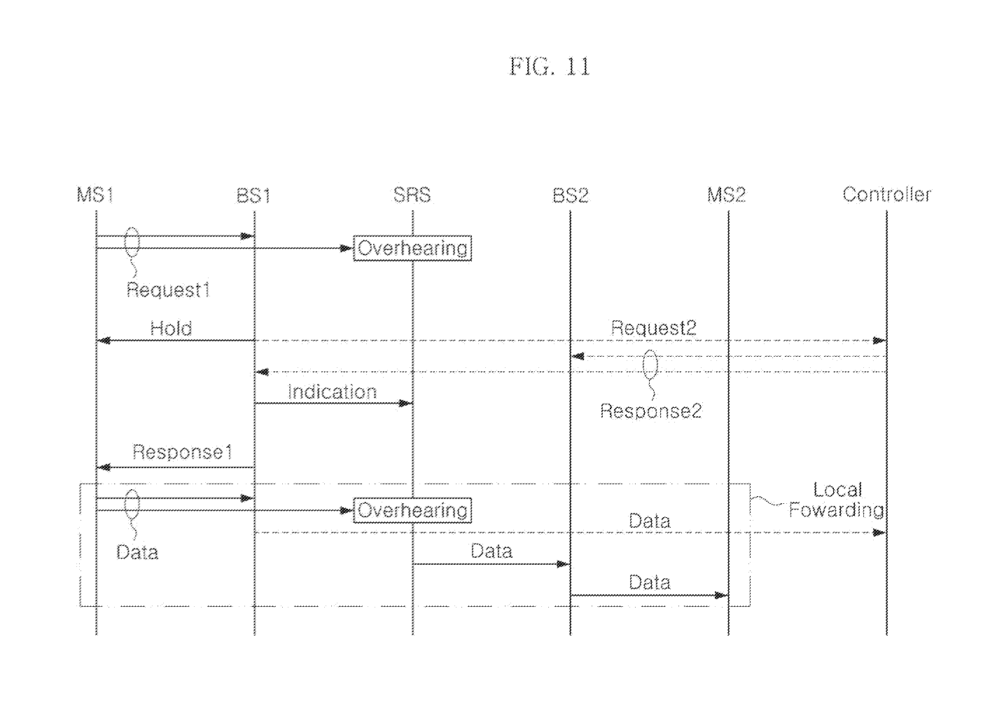

FIG. 11 shows an example of data local forwarding setting to allow terminal 1 connected to a shared relay station to perform data local forwarding to terminal 2 connected to a base station without passing through a wired backbone network in the shared relay station-based cellular network according to one embodiment of the present invention.

FIG. 11 can be used in the scenario described in FIG. 5, details are described as follows.

Terminal 1 requests base station 1 connected to terminal 1 for data local forwarding to terminal 2 (Request1). At this time, terminal 1 may send base station 1 a request message to request base station 1 for resources required for the data local forwarding. Since terminal 1 is transparent to the shared relay station although it is located in a service region of the shared relay station, terminal 1 transmits a Request1 message to base station 1.

At this time, the Request1 message transmitted by terminal 1 can be overheard by the shared relay station. Base station 1 transmits, to terminal 1, a response to the data local forwarding request message received from terminal 1 and a hold message indicating that terminal 1 is waited while base station 1 is inquiring of a controller of a core network whether or not data local forwarding from terminal 1 serviced by base station 1 to terminal 2, which is not serviced by base station 1, is possible.

At the same time, base station 1 transmits a data local forwarding request message for terminal 2 to the controller of the core network (Request2). The controller received this request message confirms which base station is connected to terminal 2, and transmits a response message indicating whether or not the data local forwarding request is possible to base station 1 connected to terminal 1 and base station 2 connected to terminal 2 (Response2).

Upon receiving the response message (Response2) from the controller of the core network, base station 1 transmits, to the shared relay station, a message indicating that terminal 1 connected to base station 1 transmits data to the shared relay station and transmits the data received from terminal 1 to base station 2 (Indication).

Base station 1 transmits, to terminal 1, a message of response to the data local forwarding request (Response1) and can allocate resources required for terminal 1 to transmit data via an uplink.

When this procedure is completed, the data local forwarding in order of terminal 1→shared relay station→base station 2→terminal 2 is achieved. At this time, since terminal 1 is transparent to the shared relay station, terminal 1 transmits local forwarding data to base station 1 and the shared relay station overhears the local forwarding data transmission. Base station 1 may transmit the data received from terminal 1 for the data local forwarding, as indicated by a dotted line, to the controller of the core network via a wired backbone network.

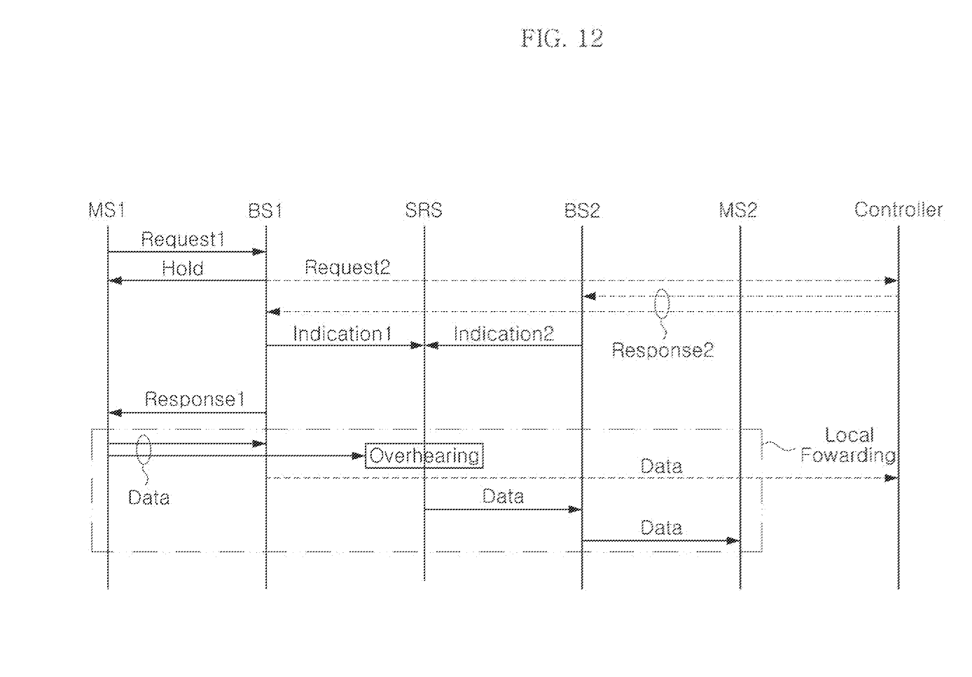

Finally, FIG. 12 shows an example of data local forwarding setting to allow terminal 1 connected to a base station to perform data local forwarding to terminal 2 connected to another base station without passing through a wired backbone network in the shared relay station-based cellular network according to one embodiment of the present invention. FIG. 12 can be used in the scenario of FIG. 6, details of which are as follows.

Terminal 1 requests base station 1 connected to terminal 1 for data local forwarding to terminal 2 (Request1). At this time, terminal 1 may send base station 1 a request message to request base station 1 for resources required for the data local forwarding.

Base station 1 transmits, to terminal 1, a response to the data local forwarding request message, indicating that terminal 1 should wait while base station 1 is inquires a controller of a core network whether or not data local forwarding from terminal 1 served by base station 1 to terminal 2 which is not served by base station 1 is possible (Hold).

At the same time, base station 1 transmits a data local forwarding request message for terminal 2 to the controller of the core network (Request2). The controller received this request message confirms which base station is connected to terminal 2, and transmits a response message indicating whether or not the data local forwarding request is possible to base station 1 connected to terminal 1 and base station 2 connected to terminal 2 (Response2). Upon receiving the response message (Response2) from the controller of the core network, base station 1 transmits, to the shared relay station, a message indicating a resource allocation request for data to be received from base station 1 (Indication1).

In addition, upon receiving the response message (Response2) from the controller of the core network, base station 2 transmits, to the shared relay station, a message indicating a resource allocation request for data to be transmitted to base station 2 (Indication2). At this time, the Indication messages received by the shared relay station include instructions to directly transmit the data received from base station 1 to base station 2.

Base station 1 transmits, to terminal 1, a message of response to the data local forwarding request (Response1) and can allocate resources required for terminal 1 to transmit data via an uplink. When this procedure is completed, the data local forwarding in order of terminal 1→base station 1→shared relay station→base station 2→terminal 2 is achieved.

At this time, since terminal 1 is transparent to the shared relay station, terminal 1 transmits local forwarding data to base station 1 and the shared relay station overhears the local forwarding data transmission. Base station 1 may transmit the data received from terminal 1 for the data local forwarding, as indicated by a dotted line, to the controller of the core network via a wired backbone network.

The data local forwarding setting may be released in accordance with the same procedure as the data local forwarding setting. For example, when the data local forwarding from terminal 1 to terminal 2 in the scenario of FIG. 3 is terminated and the data local forwarding setting is released, terminal 1 transmits a data local forwarding release request message to base station (Request1), as illustrated in FIG. 9. After transmitting a hold message to terminal 1, base station 1 requests the controller of the core network for data local forwarding release via the wired backbone network (Request2). The controller sends a response message to base station 1 requesting the controller for release of the data local forwarding to base station 2 connected to terminal 2 (Response2). At this time, the controller may delete data of terminal 1 received from base station 1 via the wired backbone network and stored in a buffer.

Base station 2 transmits, to the shared relay station, a message indicating that the data local forwarding has been terminated (Indication). Base station 1 transmits a message indicating the release completion to terminal 1 requesting the controller for the data local forwarding release (Response1).

Similarly, the scenarios of FIGS. 4, 5 and 6 release the data local forwarding in accordance with the procedures of FIGS. 10, 11 and 12, respectively.

The methods of transmitting data through the shared relay station in the mobile communication system according to one embodiment of the present invention can be implemented in the form of program instructions to be executed by a variety of computing means and may be stored in a computer-readable medium. The computer-readable medium may store program instructions, data files, data structures and so on either alone or in combination. The program instructions stored in the medium may be especially designed or configured or may be ones known and available to those skilled in the art of computer software. Examples of the computer-readable recording medium may include specific hardware devices configured to store and execute program instructions, such as magnetic media (such as a hard disk, a floppy disk and a magnetic tape), optical media (such as CD-ROM and DVD), magneto-optical media (such as floptical disks), ROMs, RAMs, flash memories and so on. Example of the program instructions may include machine language codes created by compliers and advanced language codes executable by computers using interpreters and the like. The above hardware devices may be configured to act as one or more software modules to implement the methods of the present invention.

While the present invention has been particularly shown and described with reference to exemplary embodiments thereof and the drawings, it will be understood by those skilled in the art that the present invention is not limited thereto but various changes in form and details may be made therein without departing from the spirit and scope of the present invention.

Therefore, the scope of the present invention should not be limited to and defined by the disclosed embodiments but should be defined by the appended claims and equivalents thereof.

1. A method of transmitting data through a shared relay station in a mobile communication system, comprising the steps of:
scanning, by the shared relay station, downlink channels for a plurality of base stations;
setting, by the shared relay station, downlink synchronization with the plurality of base stations from the scanned channels; and
registering, by the shared relay station, the plurality of base stations bases on the set downlink synchronization.

2. The method according to claim 1, wherein the step of scanning, by the shared relay station, downlink channels for a plurality of base stations includes: acquiring, by the shared relay station, at least one of profiles of base station transmission power and data burst using control information transmitted by the plurality of base station via the downlink channels.

3. The method according to claim 1, wherein the step of setting, by the shared relay station, downlink synchronization with the plurality of base stations from the scanned channels includes: receiving, by the shared relay station, control signals transmitted by the plurality of base stations and setting frame synchronization.

4. The method according to claim 1, further comprising the steps of:
acquiring, by the shared relay station, at least one of downlink information and uplink information on the plurality of base stations; and
performing, by the shared relay station, ranging and adjustment for the plurality of base stations based on at least one of the downlink information and the uplink information.

5. The method according to claim 4, further comprising:
negotiating, by the shared relay station, basic capability with the plurality of base stations,
wherein the step of registering, by the shared relay station, the plurality of base stations includes: registering the plurality of base stations in consideration of the negotiated basic capability.

6. The method according to claim 4, wherein the step of acquiring, by the shared relay station, at least one of downlink information and uplink information on the plurality of base stations includes:
acquiring, by the shared relay station, downlink information on the plurality of base stations; and
acquiring, by the shared relay station, uplink frame configuration information and parameters for the ranging based on uplink control information transmitted via the downlink.

7. A method of transmitting data through a shared relay station in a mobile communication system, comprising the steps of:
requesting, by a terminal, a serving base station for data local forwarding;
overhearing, by the shared relay station, the data local forwarding request performed by the terminal;
transmitting, by the serving base station, a hold message to the terminal and requesting a controller of a core network for the data local forwarding via a wired backbone network, when a data local forwarding request message is received from the terminal;
determining, by the controller of the core network, whether or not the data local forwarding is possible based on position information of terminals and replying to the serving base station and adjacent base stations connected to a terminal to receive data in the data local forwarding;
transmitting, by the serving base station, a response message received from the controller of the core network to the shared relay station;
transmitting, by the serving base station, the response message to the shared relay station;
transmitting, by the serving base station, a message of response to the data local forwarding request to the terminal;
transmitting, by the terminal requesting the serving base station for the data local forwarding, data; and
receiving, by the serving base station, the transmitted data.

8. The method according to claim 7, further comprising the step of:
overhearing, by the shared relay station, the data transmitted to the serving base station.

9. The method according to claim 7, further comprising the steps of:
transmitting, by the serving base station, the data received from the terminal to the controller via a wired backbone network; and
performing, by the serving base station, the data local forwarding and releasing the data local forwarding after completion of the data local forwarding.

10. A non-transitory computer-readable storage medium storing a computer program to cause a computer to perform the method according to claim 1.

11. A non-transitory computer-readable storage medium storing a computer program to cause a computer to perform the method according to claim 7.
